(19) United States
(12) Patent Application Publication
(10) Pub. No.: US 2007/0065476 A1
(43) Pub. Date: Mar. 22, 2007

(54) Pest control agent carrier

(76) Inventors: Stephen Sexton, Queensland (AU); Ken Ingbritsen, Queensland (AU)

Correspondence Address: Buckingham Doolittle & Burroughs, 4518 Fulton Drive NW, PO Box 35548, Canton, OH, 44735-5548, US

(21) Appl. No.: 10/569,926

(22) PCT Filed: Aug. 30, 2004
(86) PCT No.: PCT/AU04/01172

§ 371 Date: Nov. 6, 2006

(30) Foreign Application Priority Data
Aug. 29, 2003 (AU) 2003904657

(51) Int. Cl. A01N 25/08

(52) U.S. Cl. 424/410

(57) ABSTRACT

A formulation for the control of arthropod pests comprising one or more hydrophobic or non-polar semiochemicals, water, a thickener and a rubber crumb carrier. The formulation may also include additives such as a feeding stimulant or bait, toxicant or insecticide, anti-microbial agent, humectant, volatility suppressant, pigment and an anti-oxidant. The invention also includes a method of preparing a formulation for controlling arthropod pests, said method comprising the steps of (i) admixing a carrier which includes rubber crumb with one or a plurality of hydrophobic or non-polar semiochemicals for a period of time sufficient for the rubber crumb to absorb the semiochemical, wherein the semiochemical is substantially dispersed throughout the rubber crumb; and (ii) combining the rubber crumb mixture of step (i) with water or an aqueous medium comprising a thickener.

### FIELD OF INVENTION

This invention is concerned with a method of pest control. In particular, but not exclusively, the invention relates to a semiochemical formulation comprising a carrier that allows sustained release of agricultural pest control agents.

### BACKGROUND OF THE INVENTION

Pest destruction of plants and plant products creates billions of dollars of damage every year. Many devices for trapping or baiting pests, such as insect pests, are known. However, due to the impracticability and inefficiency of the devices, insecticide use has not diminished, and millions of gallons of poisonous chemicals are sprayed on crops annually.

Volatile hydrophobic semiochemicals, such as pheromones, kairomones and allomones, may be used in a number of ways for the control of arthropod pests, such as insects. These include mating disruption (use of pheromones to prevent communication and mating of pests), mass trapping (luring large numbers of pests into traps) and attract and kill technologies (attracting pests to poison baits). There are many methods of presentation and formulation of semiochemicals. These include discrete dispensers and sprays comprising microencapsulated semiochemicals. Ideally the semiochemicals are released at a constant rate and continuous manner to be effective over a significant period of time throughout the crop field or orchard. However, conventional formulations containing such semiochemicals have various disadvantages as described in more detail below.

Non-aqueous based “attract and kill” formulations such as Sirene® are known. Sirene is formulated as a thick, sticky, black substance that is tar-like in appearance and contains 0.16% codlemone and 6% permethrin, a fast-acting synthetic pyrethroid insecticide. Sirene uses the “attract and kill” concept to reduce adult male codling moth numbers which results in a decrease in mating between male and female moths and consequently decreased offspring. The paste is applied topically to branches and scaffold limbs and is unsuitable for application by spaying because it is not water dispersible. It is also unsuitable for application to foliage because of phytotoxic properties.

Water based bait formulations have some definite advantages over non-aqueous baits like Sirene®. Commercial manufacture of the water based bait formulations is usually less costly and complicated and hydrophilic feeding stimulants such as sugars or proteinaceous feeding stimulants are relatively easy to incorporate into the formulation. Suitably formulated water based baits can be applied direct to foliage efficiently, without phytotoxic effects, by spraying using mechanical means. The consistency of the formulation can be adjusted by thinning with water.

Water based bait adjuvants for insecticides and insect pathogens are used to some degree in Australian cotton fields and other broad acre crops. Products include Mobait® and Aminofeed® which target larvae which cannot fly. For this reason, they are diluted and applied to the entire crop with a cover spray.

An example of a thick, water based bait which targets adult insects is yeast autolysate and similar proteinaceous baits for fruit flies. Fruit flies are attracted to volatile semiochemicals released by the protein in the bait.

However, one major disadvantage of water based baits and formulations is that they are susceptible to being removed by rain and watering. Leafy vegetable crops, such as cabbage, lettuce, celery and sweet corn are predominantly watered by overhead irrigation resulting in wash off of the water-based bait/insecticide formulations. Therefore frequent spraying of the crops with the formulation is required which is a costly exercise.

Also another major disadvantage of water based baits and formulations is that they are not miscible or dispersible with hydrophobic volatile semiochemicals.

Oils and waxes are also frequently used as carriers for volatile hydrophobic compounds such as pheromones. U.S. Pat. No. 6,001,346, in the name of Delwiche et al., describes a sprayable or solid wax carrier comprising insect pheromones for the disruption of insect mating. The wax formulation of this patent comprises emulsifiers and therefore is phytotoxic to foliage. Consequently, the formulation is only topically applied to the bark of trees. Similarly, some humectants such as glycerol, which are used for keeping sugar based feeding stimulants moist are phytotoxic when applied thickly to foliage.

U.S. Pat. No. 5,837,273, in the name of Shasha et al., describes compositions and a method of encapsulating biologically active agents in starch-based adherent molecules for the control of insects and other pests having chewing mouth parts and amylase digestive enzymes. The granules are applied to the surface of plant foliage and adhere to the surface of foliage even in rainy and windy conditions. The disadvantage of this method is that the adherent granules are complicated in structure requiring the incorporation of pregelatinised starch and a water dispersant, and thus are costly to manufacture. The granules are not suitable for incorporation of hydrophobic volatile semiochemicals because they are hydrophilic in nature.

In summary, none of the above prior art formulations and methods combine the features of:
(i) being cheap to manufacture;
(ii) are relatively non toxic;
(iii) miscible with hydrophobic semiochemicals;
(iv) dispersible in water;
(v) adherent to plants; and
(vi) providing a slow release of the semiochemical.

### SUMMARY OF INVENTION

The inventors have surprisingly found that an aqueous suspension of rubber crumb may be used as an effective carrier for hydrophobic semiochemicals and thus provides prolonged field life or operational longevity to the semiochemicals.

In a first aspect, the invention provides a formulation for controlling arthropod pests which includes:
(i) one or more hydrophobic or non polar semiochemicals;
(ii) water;
(iii) a thickener; and
(iv) a rubber crumb carrier for said one or more semiochemicals wherein said semiochemical(s) are substantially homogenously dispersed throughout the carrier.

It therefore will be appreciated that the formulation discussed above will have advantages (i) to (vi) discussed above.

The formulation may also comprise additives, which may include a feeding stimulant or bait and toxicant or insecticide.

Suitably, the formulation may also comprise an anti-oxidant, pigment, humectant, volatility suppressant and anti-microbial agent.

The rubber crumb carrier may also comprise 1-35% carbon black as an ultraviolet protectant.

Preferably, the diameter of the rubber crumb particle size falls within the range 0.01-2.00 mm.

Preferably, the rubber crumb semiochemical mix comprises 0.01-50% semiochemical(s) by weight. More preferably, the mix comprises 0.5-50% semiochemical(s) by weight. The amount of semiochemical(s) in the final formulation is 0.001-20% by weight.

Preferably, the water or aqueous medium comprises 0.1-5% thickener in water.

Preferably, the amount of rubber crumb comprising the semiochemical(s) added to water or an aqueous medium is 0.02-50%.

The formulation can be used for the protection of crops, fruit, trees and plants from arthropod pests. This invention is particularly useful for the control of flying insect pests such as moths, flies, beetles and wasps.

The invention can be used for controlling household pests such as mosquitoes, ants, cockroaches, silverfish, fleas and bedbugs.

The formulation can also be used for the protection of livestock and pets.

In a second aspect, the invention also resides in a method of preparing a formulation for controlling arthropod pests, said method comprising the steps of:
(i) admixing a carrier which includes rubber crumb with one or a plurality of hydrophobic or non-polar semiochemicals for a period of time sufficient for the rubber crumb to absorb the semiochemical, wherein the semiochemical is substantially dispersed throughout the rubber crumb; and
(ii) combining the rubber crumb mixture of step (i) with water or an aqueous medium as well as a thickener.

In step (ii) the thickener may be incorporated with the water or aqueous medium.

The method may also include the steps of adding one or more of the additives discussed above. The additives may include a:
(a) toxicant or insecticide;
(b) feeding stimulant or bait;
(c) pigment;
(d) humectant;
(e) anti-microbial agent;
(f) volatility suppressant; and
(g) anti-oxidant.

Preferably, above additives (a), (b), (c), (d) and (e) are admixed with the aqueous medium before the rubber crumb mixture is added in step (ii).

Preferably, above additives (f) and (g) are admixed with the semiochemical(s) before the semiochemical(s) is admixed with the carrier in step (i).

Throughout this specification, “comprise”, “comprises” and “comprising” are used inclusively rather than exclusively, will be understood to imply the inclusion of a stated integer or group of integers but not the exclusion of any other integer or group of integers.

### BRIEF DESCRIPTION OF THE DRAWINGS

Reference may now be made to a preferred bailing apparatus of the invention as shown in the attached drawings wherein:

FIG. 1 is a line graph showing the number of moths killed by Formulation 1 and Formulation 2 over an 8 day period in cotton crops (Example 4). The values are a mean of 2 replicate experiments.

FIG. 2 shows the layout of Formulation 1, 2 and a ‘feeding stimulant only’ control application to seven 50 metre strips in a flowering mung bean crop (Example 5). “1” denotes Field 1. “2” denotes Field 2. “3” denotes a dam, “4” denotes a road and “5” denotes a row of crops.

FIG. 3 is a line graph showing the number of moths killed by Formulation 1, Formulation 2 and a feeding bait control formulation over an 8 day period in mung bean crops (Example 5). The values are a mean of 7 replicate experiments.

FIG. 4 is a graph showing the release of semiochemicals from Formulation 1 using headspace analysis (Example 6). Formulation 1 comprises 2% 30 mesh carrier and 0.1% Vitamin E acetate.

FIG. 5 is a graph showing the release of semiochemicals from Formulation 2 using headspace analysis (Example 6). Formulation 2 comprises 2% 80 mesh carrier and 0.1% Vitamin E acetate.

FIG. 6 is a graph showing the release of semiochemicals from Formulation 3 using headspace analysis (Example 6). Formulation 3 comprises 4% 30 mesh carrier and 0.1% Vitamin E acetate.

FIG. 7 is a graph showing the release of semiochemicals from Formulation 4 using headspace analysis (Example 6). Formulation 4 comprises 2% 30 mesh carrier and 0.4% Vitamin E acetate.

FIG. 8 is a graph showing the release of semiochemicals from Formulation 5 using headspace analysis (Example 6). Formulation 5, the control formulation, comprises no rubber crumb carrier and no anti-oxidant (Vitamin E acetate).

### DETAILED DESCRIPTION OF INVENTION

For the purposes of this invention, by “semiochemical” is a biologically active volatile compound that affects the behavior of arthropods and other organisms and includes pheromones, kairomones and allomones. Such semiochemicals may also function as pest control agents.

The formulation of the invention may also include a toxicant or insecticide as hereinafter described.

The term “rubber crumb” as used herein means particulate rubber that may be natural or synthetic in origin. Preferably, the rubber crumb is formed from chopping or cutting used vehicle tyres.

The formulation of the invention comprises rubber crumb and one or a plurality of semiochemicals in an aqueous medium. The rubber crumb acts as a slow release carrier or dispenser for the hydrophobic semiochemicals which are retained within the rubber crumb by the surrounding aqueous medium. When the formulation dries on a surface, such as a leaf surface, the water evaporates and the hydrophobic semiochemicals are able to slowly evaporate into the atmosphere. The rubber crumb carrier effectively releases the semiochemicals and significantly prolongs the half-life of the formulations (see Examples 4-6). The rubber crumb carrier/semiochemical formulations adhere to plants and are shower or rain proof (Examples 4 and 5).

The rubber crumb may be a coarse or fine powder. The rubber crumb may be 10-80 (British Standard Sieve) mesh but finer or coarser grades can be used. Preferably, the rubber crumb is 30 mesh and the diameter of the crumb particle size falls within the range 0.01-2.00 mm.

The rubber crumb may also comprise carbon black as an ultraviolet protectant at concentrations of 1-35%. The rubber crumb is preferably recycled car or vehicle tyre rubber as this is an inexpensive recycled product that is readily available in large quantities and has carbon black incorporated at a suitable concentration.

The release rate of the semiochemical from the rubber crumb particles is determined by the following factors:
the size of the rubber crumb particles;
the surface area of the droplets of paste or liquid applied to the plant surface;
the ratio of the aqueous medium to the rubber carrier mix;
the concentration of sugars (if any) in the aqueous medium;
the molecular weight and vapour pressure of the semiochemicals; and
the presence of volatility suppressants in the formulation.

The semiochemicals may be any biologically active volatile compound. Examples of kairomones are provided in U.S. Pat. No. 6,074,634, in the name of Lopez et al., incorporated herein by reference. The mixture of kairomones described in U.S. Pat. No. 6,074,634 or similar mixtures of plant semiochemicals or volatiles are effective in attracting Helicoverpa and related noctuid moth pests. When used in combination with a feeding stimulant such as sucrose and a suitable toxicant, this product is useful for control of moths such as Helicoverpa spp. and Spodoptera spp., the larvae of which species are highly destructive pests of agriculture, lawns and turf.

Examples of noctuid attractants are provided in International Patent Application No. PCT/AU02/01765, in the name of Bioglobal Ltd, also incorporated herein by reference. Examples include phenylacetaldehyde, methyl 2-methoxybenzoate, limonene, methyl salicylate, anisyl alcohol, beta caryophyllene, anethole and linalool.

The formulation comprises 0.02-50% by weight of rubber crumb semiochemical mix depending on the application and the presence of other ingredients, such as feeding stimulants. Various proportions of semiochemicals, rubber crumb and aqueous medium are suitable for the formulation. In general the ratio of rubber crumb to semiochemical must be high enough to ensure the maximum amount of semiochemical is absorbed into the rubber crumb.

The thickening agent used in the formulation of the invention may be any substance that increases the viscosity of the formulation. The thickening agent may be used singly or a combination of thickening agents may be utilised. The thickening agent may be a polymer which can be linear, branched or cross-linked and may be naturally derived, or may be synthetic. Any of the hydrophilic gelling or thickening agents described by Scott Hegenbart (1993, Food Product Design, http://www.foodproductdesign.com/archive/1993/0193CS.html) may be used. Such polymers include a range of vegetable gums including cellulose derivatives, naturally derived polysaccharides and synthetic polymers inclusive of polyethylene glycols, polyethylene oxides, polyvinyl pyrrolidones and polyacrylic acid. Protein gums such as gelatin and gluten may also be useful. Preferably, the thickener is an organic hydrophilic gum such as xanthan, carboxymethyl cellulose, alginates, carrageenan, locust bean gum, tragacanth and guar.

The formulation can be formulated as an “attract and kill” formulation which includes a feeding stimulant in combination with one or a plurality of toxicants or insecticides to stimulate a pest to eat the formulation.

The feeding stimulant may be selected from the group consisting of proteinaceous insect feeding stimulants such as liquid yeast autolysate, cucurbitacin compounds, sugars such as glucose, sucrose and fructose, cottonseed meal and similar oilseed meals and farinaceous meals.

The toxicant or insecticide may be selected from the group consisting of carbaryl, methomyl, acephate, thiodicarb, cyfluthrin, malathion, chlorpyrifos ethyl, chlorpyrifos methyl, parathion methyl, parathion ethyl, malathion, emamectin benzoate, abamectin, spinosad, endosulfan, Phloxine B and mixtures thereof.

Pigment may be added to the formulation to make the formulation less attractive to birds and insects that are not pests. This is particularly important where sugar based feeding stimulants are used. For example, the addition of a green or red pigment into sugar-based baits makes the formulation less attractive to honeybees. Preferably, the pigments are ferric oxide, titanium dioxide or Kraft food dyes.

Anti-oxidants may be any substance that improve the shelf life of the formulation and prevent unwanted degradation and/or oxygenation of the active agents in the formulation, such as the labile semiochemicals (see Example 6). Preferably, the anti-oxidants are selected from the group consisting of vitamin E, vitamin E acetate, butylated hydroxytoluene and butylated hydroxyanisole.

A volatility suppressant may be added to the formulation to suppress and/or slow down the volatility of the volatile attractant or repellant to increase the half-life of the formulation. The volatility suppressant may include alpha tocopherol, alpha tocopherol acetate, oils or waxes of animal, vegetable or mineral origin, shellac, rosin and synthetics such as silicones and acrylates. The compounds may be dissolved and incorporated into the rubber crumb carrier with the hydrophobic semiochemicals to reduce the volatility of the semiochemicals.

A humectant may be added to the aqueous medium to improve the consistency and palatability of the formulation and to prevent the sugar feeding stimulant, when used, drying and flaking off surfaces to which the formulation is applied. Humectants may include glycerol, sorbitol glucose, fructose and invert sugar. In applications where phytotoxicity is a concern, glycerol should be avoided and glucose, fructose and invert sugar are preferred.

Wetting agents or surfactants may also be included in the formulation to stabilize the formulation. Preferably, a non phytotoxic amount of 0.1-2.0% by weight is used. Wetting agents or surfactants may be amphoteric, cationic, ionic, or nonionic and may include alkyl polysaccharides, ether sulphates, ether phosphates, sulphosuccinates, ether carboxylates, naphthalene sulphonic acid salts, naphthalene sulphonate formaldehyde condensates, tristyrylphenol ethoxylates, castor oil ethoxylates, phosphate esters and condensates, aromatic hydrocarbon sulphonic acids and their salts and condensates, oleo-derived nonionic surfactants including sorbitan esters and polysorbates, alkyl polysaccharides, ethoxylates of natural alcohols and polyglycol fatty acid esters, fatty alcohol sulphates and fatty alcohol ether sulphates, mono-alkyl sulphosuccinates, alkyl ether carboxylates, sodium lauryl sulphate, alkyl ampho(di)acetates, alkyl dimethylamines, amine oxides, alkyl betaines, alkyl amideobetaines, fatty acid alkanolamides, alkylphenol ethoxylates, fatty alcohol ethoxylates, fatty amine ethoxylates, ethylene oxide-propylene oxide copolymers, ethylene glycol esters, fatty amine ethoxylates, fatty acid alkanolamides, fatty alcohol ethoxylates, lauric acid alkanolamides, nonylphenol ethoxylates, octylphenol ethoxylates, polyglycol esters of castor oil, dodecylphenol ethoxylates, dinonylphenol ethoxylates, sodium dioctyl sulphosuccinates, polyglycol esters of stearic acid, octylphenol ethoxylates and alcohol ethoxylates.

Method of Formulation Preparation

The semiochemical(s) is incorporated into the rubber crumb using a mixer such as a ribbon blender or a cement mixer. Preferably, the ratio of 1 part semiochemical to 1 to 2 parts rubber crumb by weight is used. However, the ratio may be reduced to 1:100 if required, for example, if the semiochemical is very potent.

Preferably, the semiochemical(s) and rubber crumb are mixed for 10-60 minutes and left to stand for 30-120 minutes. The resultant semiochemical/rubber crumb mixture is dry or slightly oily in texture with the consistency of a flowable powder, not a liquid.

The formulation can be mixed at room temperature, thereby avoiding high heating and subsequent cooling costs and expensive residence times in the mixing equipment.

The semiochemical(s) can be mixed with a volatility suppressant or an anti-oxidant, such as BHT, BHA and alpha tocopherol acetate, prior to incorporation into the rubber crumb.

Preferably, the volatility suppressant is mixed in the proportion of 10 parts semiochemical to 1 part volatility suppressant. However, the proportion may vary from 1 part semiochemical to 1 part volatility suppressant, to 100 parts semiochemical to 1 part volatility suppressant, depending on the vapour pressure of the semiochemicals and the characteristics of the formulation desired.

Preferably, the anti-oxidant is mixed in the proportion of 5 parts semiochemical to 1 part anti-oxidants. The proportion may be varied according to the stability of the semiochemicals. Hexane or another hydrocarbon solvent may be used to dilute the semiochemicals as required.

If a toxicant and/or insecticide and hydrophilic feeding stimulant or bait, such as sucrose, fructose, glucose or invert sugar, is required in the formulation, they are admixed with the aqueous medium before the aqueous medium is combined with the semiochemical/rubber crumb mix. They can be dissolved with the thickener, such as xanthan gum, using a high speed blender.

Hydrophilic additives such as anti-microbials and buffers can also be added at this time.

Subsequently, the semiochemical/rubber crumb mixture is added to the aqueous medium with high speed agitation until it is evenly incorporated.

Mineral pigments such as titanium oxide, zinc oxide or ferric oxide may then be added and the formulation is mixed until the pigment is dispersed evenly. If sugar based feeding stimulants are used, ferric oxide or green food dye is preferably used. Red or green colouring is not attractive to diurnal beneficial insects such as bees.

The concentration of the semiochemical/rubber crumb mix, the feeding stimulants and thickeners can be varied according to the desired requirements for the end product which may have the viscosity that ranges from a thick paste to a thin cream.

Wetting agents and emulsifiers, such as alkyl polysaccharides and ether sulphates, may be optionally added to the formulation at the same time as the other hydrophilic additives are incorporated into the aqueous medium.

Insecticides may also be added to the formulation prior to sale or may be added by a farmer prior to use.

If a sugar based feeding stimulant is used in an “attract and kill” formulation, it may be desirable to use a “fast knockdown insecticide” either alone or in combination with a slow acting insecticide. This may minimize the undesired destruction of bees that are attracted to the toxic bait. The “fast knockdown insecticide” will kill rapidly any scout bees that may locate the bait and will therefore prevent the scout bees communicating the whereabouts of the toxic bait to the other bees in the hive.

The final formulation is suitable for application as a paste applied from a tube, or can be applied as a thick liquid using suitable combinations of pumps and tanks on a tractor, farm motorbike or from an agricultural spray plane.

For the control of corn rootworm and cucumber beetles (Diabrotica and Acalymma spp.), 1,2,4-trimethoxybenzene, indole, cinnamaldehyde, 4-methoxycinnamaldehyde and cinnamyl alcohol may be used as semiochemicals (Metcalf and Metcalf, U.S. Pat. No. 6,613,317).

The semiochemical/rubber crumb mix may also be mixed with cucurbitacin adsorbed onto the surface of a suitable hydrophilic carrier, such as woodflour or a cellulose powder. The mixture can then be incorporated into an aqueous medium together with a toxicant or insecticide. This formulation can be applied as a paste or as a thick liquid to tomatoes, cucumbers, corn or other susceptible garden plants and agricultural.

For the control of fruit flies a formulation comprising a kairomone such as cue-lure, methyl eugenol, raspberry ketone, terpinyl acetate, ginger root oil and similar known attractants may be effective. The formulation may also include a feeding stimulant, such as yeast autolysate and a suitable toxicant. The formulation can be applied as a paste or as a thick liquid to fruit trees or bushes to prevent infestation of fruit.

For the control of aphids, aphid alarm pheromones such as E, beta farnesene may be incorporated into rubber crumb. No feeding stimulant or toxicant would be required in the formulation. Volatile repellents of aphids or kairomonal attractants for aphid predators may be added to the formulation to complement the aphid alarm pheromone.

In use, a paste of the formulation may be applied directly to the plants or crops, or may be applied to the plant support stakes, for example tomato stakes.

The spray of the formulation can be applied to one row of plants in fifty in large filed crops, such as cotton.

The formulation may also be used to attract and kill arthropod pests of animals or livestock. The formulation can be applied to fences or housing surrounding the animals. The rubber crumb formulation can also be used as a carrier for the release of plant volatiles, such as limonene or tea tree oil, for direct control of insects, such as ants and cockroaches, in confined spaces (inside houses) for fumigation purposes.

The invention as shown in the preferred embodiment has the following advantages and uses:
1. minimal risk of plant phytotoxicity;
2. decreased environmental pollution due to specific application of the formulation and biodegradability of the formulation;
3. lower levels of the active semiochemicals and agents may be used to achieve the same level of pest control as achieved by commercial formulations containing higher levels of the active agents;
4. a decreased amount of formulation is applied per area because the semiochemicals bring pests to the bait instead of relying on complete coverage of the area or plants;
5. the carrier provides a constant rate and continuous release of the semiochemical;
6. increased safety to the user;
7. the formulation is suitable for incorporation with water soluble or insoluble feeding stimulants and toxicants as part of an “attract and kill” formulation;
8. the addition of green or red pigment into sugar based baits makes the formulation less attractive to honeybees;
9. the formulation uses a non-toxic, biodegradable and inexpensive recycled rubber crumb carrier which can be obtained from vehicle tyres; and
10. when combined with semiochemicals rubber crumb remains a flowable powder. Therefore, the formulation can be mixed at room temperature, thereby avoiding high heating and subsequent cooling costs and expensive residence times in the mixing equipment.

### EXAMPLES

### Example 1

An attractant feeding stimulant formulation for control of adult Noctuidae, such as Helicoverpa and other lepidopterans.

| Ingredients | Percentage w/w |
|---|---|
| Sucrose | 40.0% |
| Golden syrup (invert sucrose) | 10.0% |
| Water | 43.1% |
| Xanthan | 1.00% |
| Titanium oxide | 1.00% |
| Kraft apple green food dye | 0.05% |
| Hydrophobic volatile moth attractants | 2.00% |
| BHT | 0.40% |
| Vitamin E Acetate | 0.40% |
| Rubber crumb 30 mesh | 2.00% |
| Total | 100% |

Application - 2-4 kilograms per hectare

### Example 2

An attractant feeding stimulant formulation for control of Corn rootworm beetles. The toxicant or insecticide can be added prior to use by farmers.

| Ingredients | Percentage w/w |
|---|---|
| Woodflour 50 mesh | 20.0% |
| Cucurbitacin E Glycoside (10% in ethanol) | 0.4% |
| Water | 72.7% |
| Xanthan | 2.00% |
| Titanium oxide | 1.00% |
| Potassium sorbate | 0.10% |
| Hydrophobic volatile beetle attractants | 1.00% |
| BHT | 0.40% |
| Vitamin E Acetate | 0.40% |
| Rubber crumb 30 mesh | 2.00% |
| Total | 100% |

Application - 1 kilogram per hectare as a bait spray to corn.

### Example 3

A repellent mixture for aphids comprising akairomone for attracting aphid predators.

| Ingredients | Percentage w/w |
|---|---|
| Water | 48.0% |
| Xanthan | 2.0% |
| Potassium sorbate | 2.0% |
| Ferric Oxide | 2.0% |
| Hydrophobic aphid predator kairomone (50% Z,3 | 15.0% |
| hexenyl acetate and 50% methyl salicylate) | |
| Hydrophobic aphid alarm pheromone - E beta | 5.0% |
| farnesene | |
| BHT | 1.0% |
| Vitamin E Acetate | 5.0% |
| Rubber crumb 30 mesh | 20.00% |
| Total | 100% |

The formulation is mixed using a dough mixer and applied as a paste to rose bushes.

### Example 4

Field life and rain resistance oftwo attractant formulations for control of adult female Helicoverpa spp. moths in cotton.

Ingredients of Formulation 1

Formulation 1 includes attractants in a rubber crumb carrier suspended in aqueous sugar solution.

| | Percentage w/w |
|---|---|
| Sucrose | 40.00% |
| Invert sucrose | 10.00% |
| Water | 43.65% |
| Xanthan | 1.00% |
| Titanium dioxide | 0.50% |
| Kraft apple green food dye | 0.05% |
| Semiochemicals | 2.30% |
| Anti-oxidants | 0.50% |
| Rubber crumb 30 mesh | 2.00% |
| | 100.00% |
| Semiochemicals | |
| Phenylacetaldehyde 50% in dpg | 0.60% |
| Methyl 2methoxybenzoate | 0.30% |
| Limonene | 0.20% |
| Methyl salicylate | 0.20% |
| Z,3 Hexenyl acetate | 0.20% |
| 4 methoxybenzyl alcohol | 0.20% |
| beta caryophyllene | 0.20% |
| Anethole | 0.20% |
| linalool | 0.20% |

Ingredients of Formulation 2

Formulation 2 was a commercially available product with similar active ingredients to Formulation 1. However, the active ingredients were added directly to the aqueous medium without the use of the rubber crumb carrier.

Methods

Both formulations were applied to the cotton plants at the same time. Two fields of cotton were treated.

Formulation 1 in combination with 20 ml of Larvin® was applied at an amount of 1000 ml per 100 metres to 4×50 metre strips on rows located between those treated with Formulation 2. Formulation 2 in combination with Marlin® toxicant at 30 ml per litre of formulation was applied to whole rows of cotton at an amount of 750 ml per 100 metres to rows spaced 72 m apart.

Field 1 was planted with Bollgard II cotton. Two rows, 72 metres apart, were treated with 750 ml per 100 metres of row of Formulation 2 in combination with Marlin® toxicant at 30 ml per litre of formulation. Two rows, 36 metres each side of the Formulation 2 treated rows, were treated with Formulation 1 in combination with 20 ml of Larvin® per litre.

Field 2 was planted with conventional cotton and treated with Formulation 2 with Marlin® toxicant at 30 ml per litre of formulation at an amount of 750 ml per 100 metres to rows spaced 72 m apart. Formulation 1, in combination with 20 ml of Larvin® per litre, was applied to rows of cotton 36 metres on either side of the rows treated with Formulation 2.

Counts of dead moths were made along two rows on either side of the treated rows. Counts were carried out 1, 3, 6 and 8 days after application of the formulations.

Results

Formulation 1 remained effective without a detectable decline in activity for the eight day period of this trial. Deposits of Formulation 1 remained largely intact and effective after two falls of rain, demonstrating that the formulation is ‘shower or rain proof’.

Formulation 2 was almost as active as Formulation 1 on the first night of application but its activity deteriorated after the second day. Formulation 2 appeared to have no resistance to rain.

The number of moths per 50 metres, 2 rows of crops were checked each side of the treated row.

| | | |
|---|---|---|
| Field 1 | Field 2 | No. of moths |

| | | | | | |
|---|---|---|---|---|---|
| Replicate | 1 | 2 | 3 | 4 | Total |

Day 1

| | | | | | |
|---|---|---|---|---|---|
| Formulation 2 | 1 | 4 | 1 | 0 | 6 |
| Formulation 1 | 1 | 6 | 2 | 1 | 10 |

Day 3

| | | | | | |
|---|---|---|---|---|---|
| Formulation 2 | 2 | 1 | — | — | 3 |
| Formulation 1 | 3 | 11 | — | — | 14 |

Day 6

| | | | | | |
|---|---|---|---|---|---|
| Formulation 2 | 1 | 0 | — | — | 1 |
| Formulation 1 | 7 | 8* | — | — | 15 |

Day 8

| | | | | | |
|---|---|---|---|---|---|
| Formulation 1 | 13 | 20* | — | — | 15 |

*includes one armyworm moth - probably Spodoptera spp.

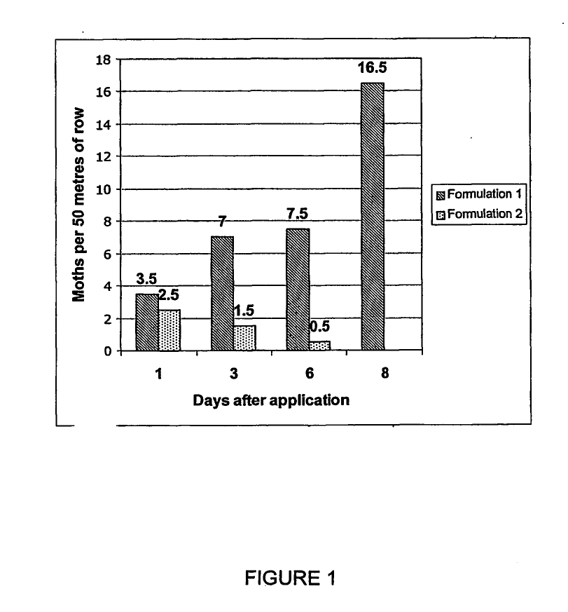

The gaps in the data on Field 2 were due to irrigation applied to Field 2. FIG. 1 is a graph showing the number of moths killed by Formulations 1 and 2 over the trial period.

Formulation 1 remained active on Day 8 even though 10 mm of rain fell on the trial site the previous night. The rain resulted in complete wash-off of Formulation 2 and only partial loss and repositioning of Formulation 1.

Discussion

Based on the observations of the performance of the two formulations the following conclusions can be drawn:
Formulation 1 is clearly a superior formulation in comparison with Formulation 2. Formulation 1 and Formulation 2 were equally effective in killing moths on Day 1. After Day 1 the effectiveness of Formulation 2 deteriorated significantly. The difference in performance between the two formulations is most likely due to the fact that Formulation 1 comprised a carrier whereas Formulation 2 did not.
Formulation 1 remained effective for at least eight days without any observable fall in performance. On the sixth day the deposits of Formulation 1 were still visible and noticeably fragrant. By comparison Formulation 2 appeared to lose most of its activity and fragrance by the third day.
Formulation 1 remained active after 20 mm of rain. It is therefore reasonable to conclude that the product is shower proof.

### Example 5

Field life and rain resistance of two attractant formulations for control of adult female Helicoverpa spp. moths in mung beans.

Two formulations comprising a feeding stimulant/attractant mixture for adult male and female Helicoverpa spp. moths were compared with a feeding stimulant only control. The formulations differed principally in that Formulation 1 comprised a rubber based controlled release system or carrier for the attractant volatiles while Formulation 2 did not comprise a carrier. The control formulation comprised a sugar based aqueous medium.

| | Percentage w/w |
|---|---|
| Ingredients of Formulation 1 | |
| Sucrose | 40.00% |
| Invert sucrose | 10.00% |
| Water | 43.65% |
| Xanthan | 1.00% |
| Titanium dioxide | 0.50% |
| Kraft apple green food dye | 0.05% |
| Semiochemicals | 2.30% |
| Anti-oxidants | 0.50% |
| Rubber crumb 30 mesh | 2.00% |
| | 100.00% |
| Formulation 2 | |
| Phenylacetaldehyde 50% in dpg | 0.60% |
| Methyl 2methoxybenzoate | 0.30% |
| Limonene | 0.20% |
| Methyl salicylate | 0.20% |
| Z,3 Hexenyl acetate | 0.20% |
| 4 methoxybenzyl alcohol | 0.20% |
| beta caryophyllene | 0.20% |
| Anethole | 0.20% |
| linalool | 0.20% |

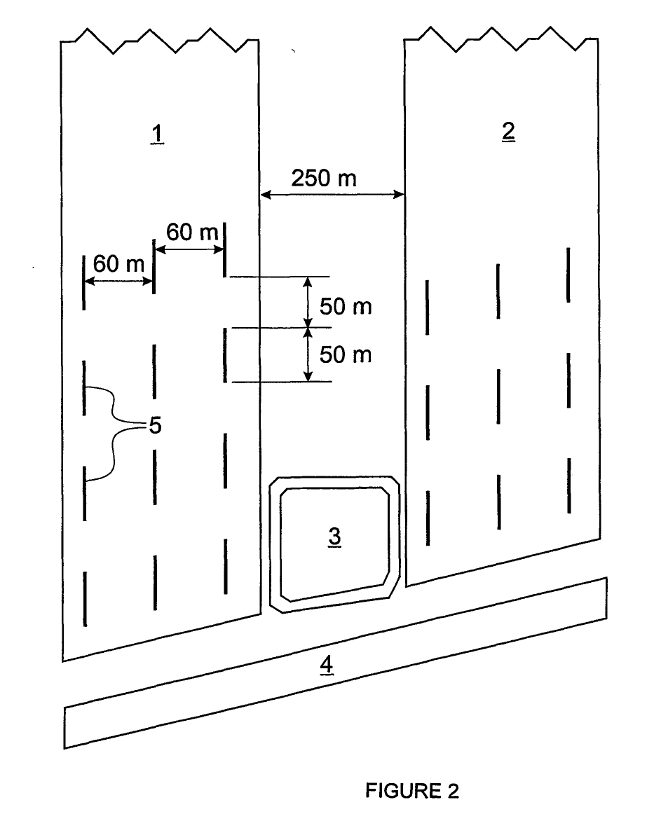

Formulations 1 and 2 and the ‘feeding stimulant only’ control were each applied to seven 50 metre strips in a flowering mung bean crop according to the layout indicated in FIG. 2. Formulation 1 and the control were applied at an amount of 1000 ml per 100 metres using Larvin 375® toxicant at an amount of 20 ml per litre of formulation. Formulation 2 was applied at an amount of 750 ml per 100 metres of crops using Marlin® toxicant (30 ml per litre of formulation). Formulations 1, 2 and the control formulation were randomly applied to the rows of crops. The effectiveness of the formulations were assessed by the number of moths killed on days 1, 2, 4, 6 and 8 post treatment. Dead moths were collected in the two adjoining rows of crops on either side of the treated row. Moths were identified by genus only.

Results

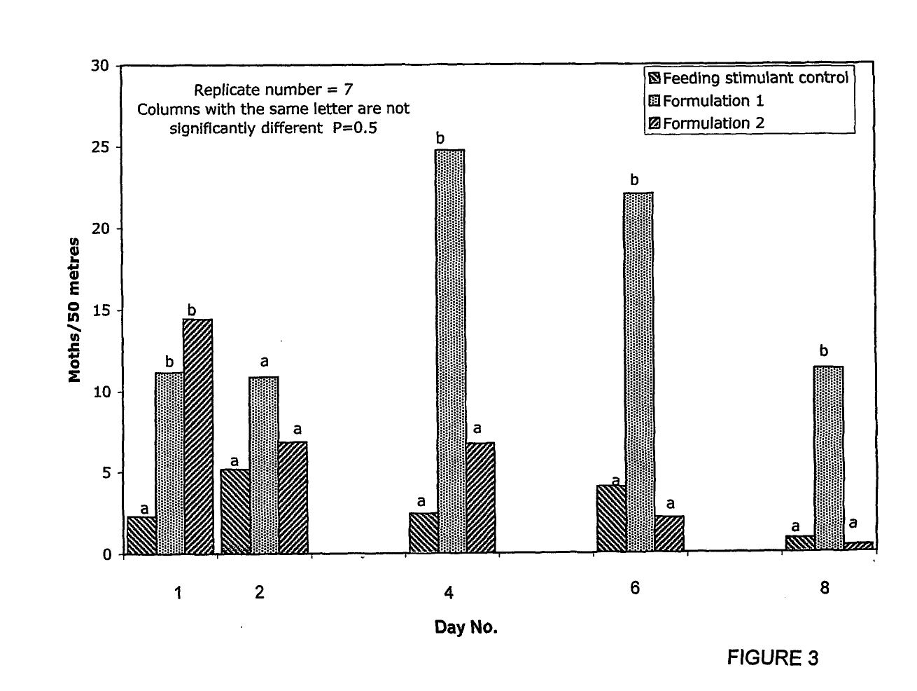

On Days 1 and 2 both Formulations 1 and 2 were equally effective and killed significantly more moths than the control formulation. After Day 2 Formulation 1 killed progressively more moths on subsequent days and Formulation 2 killed significantly less moths. The results indicate (FIG. 3) that Formulation 1 is superior to both Formulation 2 and the feeding stimulant control throughout the 8 day trial.

Discussion

On day 8, at the end of the trial, the crop was senescing and therefore no longer attractive for moths. Formulation 1 remained effective but the number of moths in the locality was declining. Evidence of the decline is supported by the declining number of moths killed by the ‘feeding stimulant only’ control over the 8 days. Therefore, it can be concluded that the field life of Formulation 1 is at least 8 days.

### Example 6

Headspace analysis was carried out to measure the amount of semiochemicals released from a range of rubber crumb semiochemical formulations.

The release rates of seven biologically active semiochemicals in a number of rubber crumb carrier formulations and in a control formulation (which did not comprise a carrier) were examined by headspace analysis using gas chromatography and mass spectrometry. The release of the semiochemicals from the ‘no carrier’ control was high and decreased rapidly over the first three or four days of the experiment. The incorporation of the semiochemicals into 30 mesh rubber crumb at an amount of 1 gram of semiochemicals per gram of rubber crumb resulted in a marked slowing of the release from the formulation when compared with the ‘no carrier’ control. Incorporation of the semiochemicals into a finer grade of rubber crumb (80 mesh) gave a steady but higher release rate. Increasing the Vitamin E acetate (anti-oxidant) content from 0.1% to 0.4% slowed the release rate of the semiochemicals. Increasing the 30 mesh rubber content from 2% to 4% (semiochemical content remaining constant) also slowed the release of the semiochemicals.

Experimental Formulations

Five experimental formulations were prepared by mixing semiochemicals (Table 1) with various rubber crumb carriers (Table 3) into an aqueous sugar solution base (Table 2).

TABLE 1
Percentage by weight of the ingredients in the mixture of
semiochemicals and stabilisers*

| | Percentage by |
|---|---|
| Semiochemicals and stabilisers | weight |
| Methyl 2-methoxybenzoate | 15 |
| Limonene | 10 |
| Methyl salicylate | 10 |
| Z,3 Hexenyl acetate | 10 |
| beta caryophyllene | 10 |
| Anethole | 10 |
| linalool | 10 |
| BHT (anti-oxidant) | 20 |
| Vitamin E Acetate | 5 |

*common to all formulations

TABLE 2
Percentage by weight of the ingredients in the aqueous sugar solution

| | |
|---|---|
| Cane sugar | 40.0 |
| Invert sugar | 10.0 |
| Water | 48.6 |
| Xanthan (thickener) | 0.8 |
| Titanium dioxide | 0.5 |
| Kraft apple green | 0.1 |

*common to all formulations

The mixture of semiochemicals and stabilisers (Table 1) was incorporated into the rubber carrier and allowed to stand for one hour. This mixture was then incorporated into the aqueous sugar solution (Table 2). No carrier was used with experimental Formulation 5. The semiochemicals were directly incorporated into the base. The experimental formulations are summarized in Table 3.

TABLE 3
Percentage by weight of the ingredients in the experimental
formulations

| | | Semio- | 30 mesh | 80 mesh | Additional |
|---|---|---|---|---|---|
| Formulation | | chemical | rubber | rubber | Vitamin E |
| number | Base | mixture | carrier | carrier | Acetate |
| 1 | 96.00 | 2.00 | 2.00 | 0.00 | 0.00 |
| 2 | 96.00 | 2.00 | 0.00 | 2.00 | 0.00 |
| 3 | 94.00 | 2.00 | 4.00 | 0.00 | 0.00 |
| 4 | 95.85 | 2.00 | 2.00 | 0.00 | 0.15 |
| 5 | 98.00 | 2.00 | 0.00 | 0.00 | 0.00 |

Headspace Methodology

300 milligram samples ofthe above experimental formulations were placed in 8 mm diameter plastic bottle lids. The lids were exposed in a simulated outdoor situation with free air movement. The samples were not directly exposed to rain but were subject to fluctuations in humidity.

The lids containing the experimental formulations were tested on days 1, 2, 4 and 7 after exposure. The lids were placed in the bottom of 20 ml glass sample vials and allowed to equilibrate for 20 minutes. The semiochemical ingredients in the headspace sample were sampled using Solid Phase Micro Extraction and measured and analysed with a Varian gas chromatograph/mass spectrometer.

Results

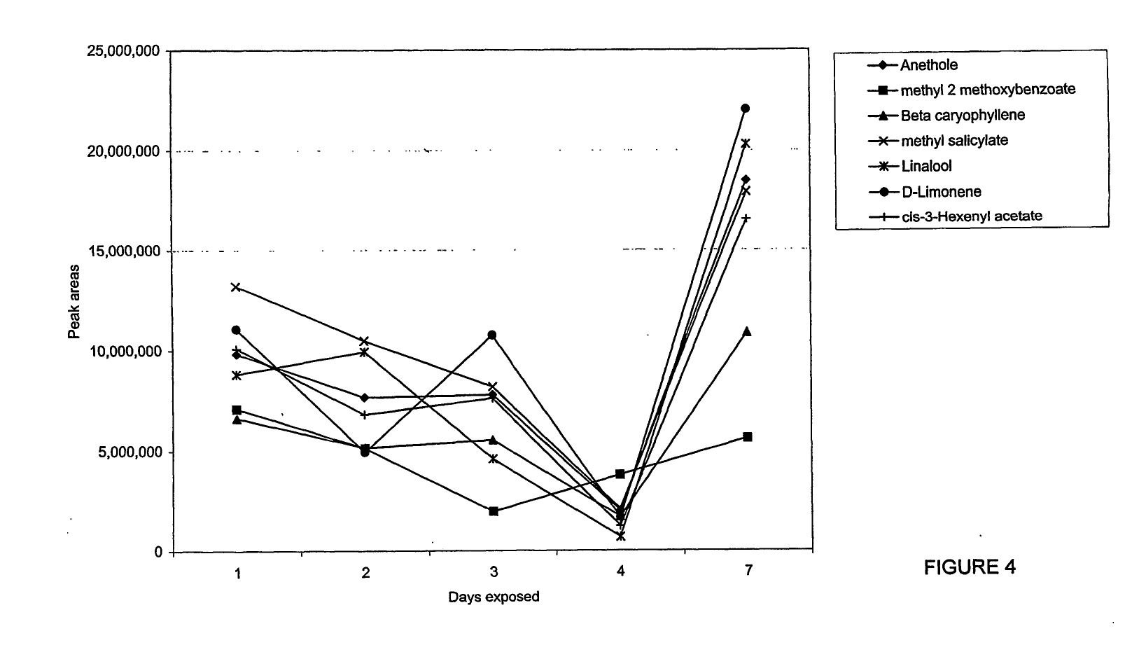

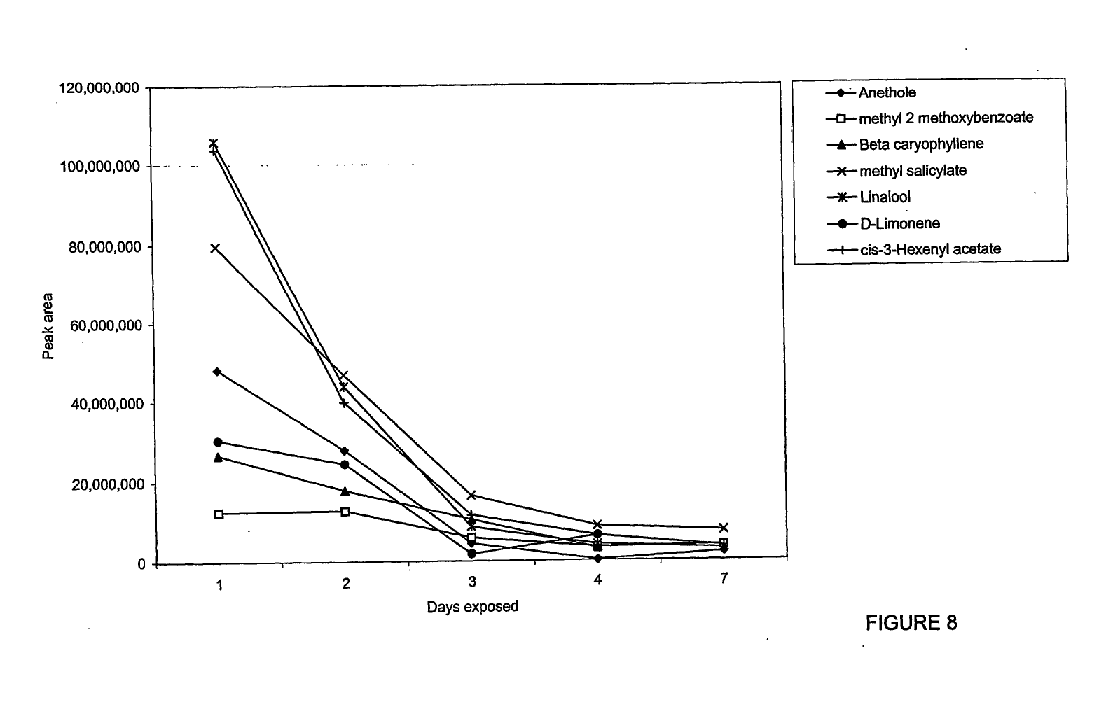

The results are presented in FIGS. 4-8. The release of Formulation 1 comprising 2% 30 mesh carrier and 0.1% Vitamin E acetate slowly decreased over the first 3 days and increased considerably on Day 4. The release continued to increase until the end of the trial (7 days).

The release of Formulation 2 comprising 2% 80 mesh carrier and 0.1% Vitamin E acetate slowly fluctuated over the 4 days but the average semiochemical release did not substantially change over that time. The release continued to increase until the end of the trial (7 days).

The release of Formulation 3 comprising 4% 30 mesh carrier and 0.1% Vitamin E acetate was stable over the first 3 days and accelerated on Day 4. The release continued to increase until the end of the trial (7 days).

The release of Formulation 4 comprising 2% 30 mesh carrier and 0.4% Vitamin E acetate decreased by Day 2 and accelerated on Day 3. The release continued to increase until the end of the trial (7 days).

The release of Formulation 5, the control formulation comprising no rubber crumb carrier and no anti-oxidant was very high on Day 1. However, the release decreased exponentially over the following days. By day 3 the levels of semiochemicals were barely detectable.

Discussion

The results of the headspace analysis demonstrated clear and significant differences between the release of semiochemicals in the different formulations.

The results for control Formulation 5 (in which the semiochemical active ingredients were incorporated directly into the aqueous base) demonstrate emission of semiochemicals from the formulation stops on Day 3 to Day 4. Therefore the usefulness of such a formulation is very limited after three or four days.

The results of Formulations 1 to 4 (comprising a rubber crumb carrier) demonstrate the presence of the rubber crumb carrier significantly prolongs the emission of semiochemicals from the formulations.

Rainfall occurred between Days 3 and 4, resulting in cooler conditions and a decline in the semiochemical release rate observed on Day 4. However, the release rates in all the carrier containing formulations returned to normal day 7 and showed no signs of decreasing. The results indicate clearly that the formulations incorporating the rubber carrier continued to effectively release semiochemicals on Day 7.

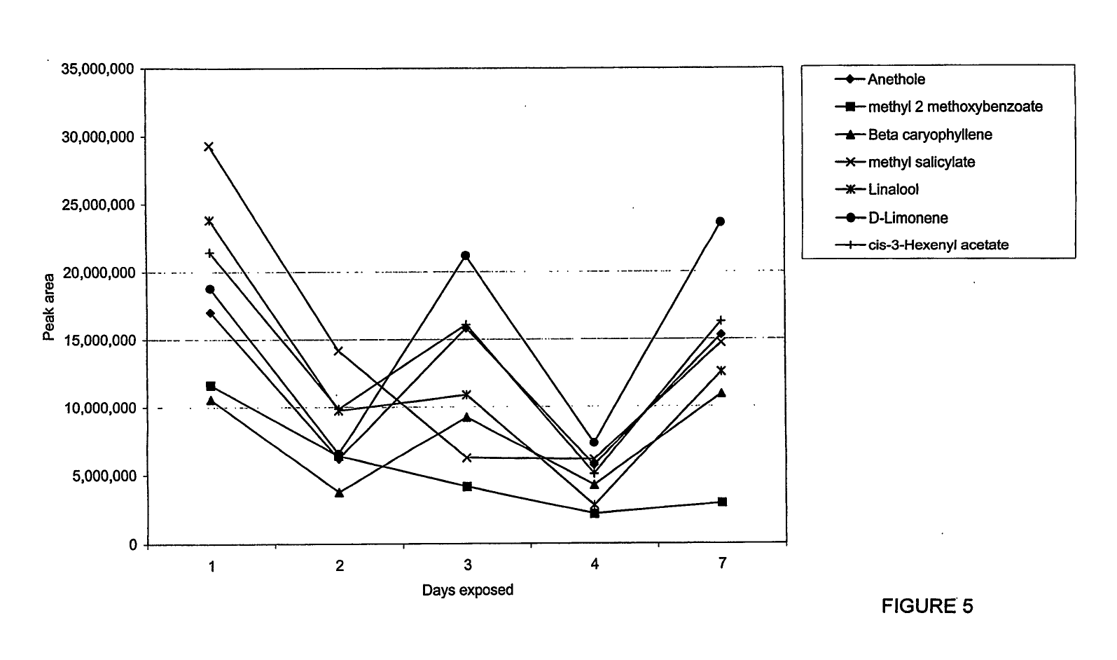

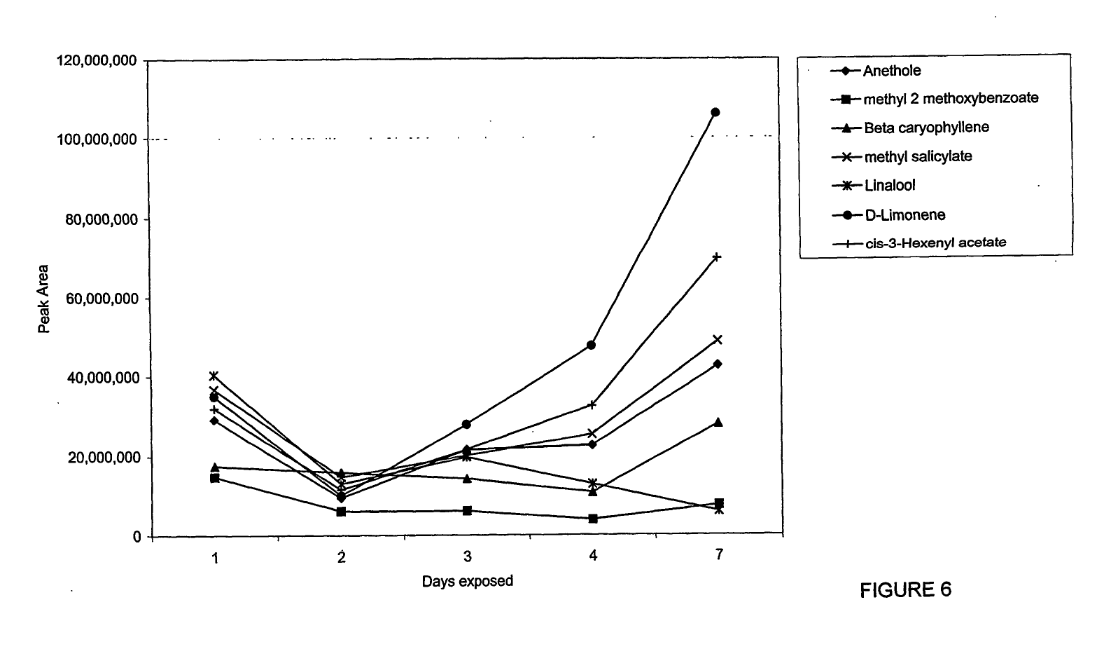

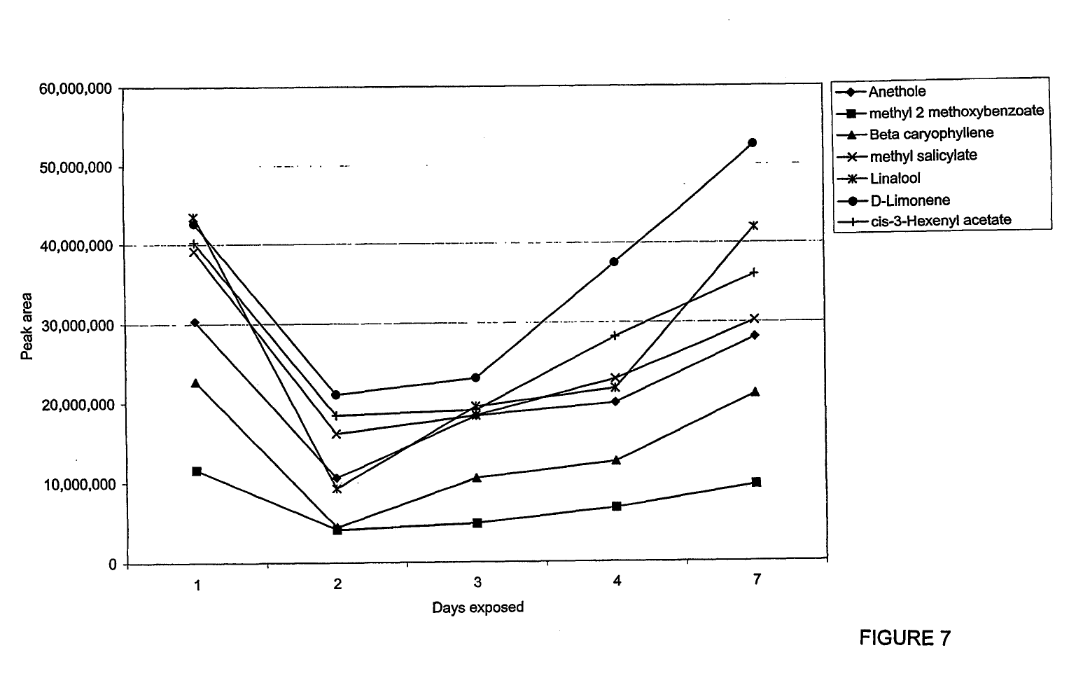

Use of a fine 80 mesh rubber carrier (FIG. 5; Formulation 2), a higher amount of carrier in the formulation (FIG. 6; Formulation 3) or more Vitamin E Acetate (FIG. 7; Formulation 4) further improved the effectiveness of semiochemical release from the formulations.

In conclusion, the inclusion of a rubber crumb carrier in a semiochemical formulation dramatically prolongs release of the semiochemicals from the formulation. Semiochemical release is prolonged if a larger amount of rubber crumb carrier is used and if larger particles of the carrier are used in the formulation. Increasing the amount of the anti-oxidant alpha tocopherol slowed down the release of the semiochemicals.

1. A formulation for the control of arthropod pests comprising one or more hydrophobic or non polar semiochemicals, water or an aqueous medium, a thickener and a rubber crumb carrier for said one or more semiochemicals wherein said semiochemical(s) are substantially homogenously dispersed throughout the carrier.

2. The formulation of claim 1 wherein the formulation comprises an additive which is a feeding stimulant or bait.

3. The formulation of claim 1 wherein the formulation comprises an additive which is an insecticide or toxicant.

4. The formulation of claim 1 wherein the formulation comprises an additive selected from the group consisting of an anti-oxidant, pigment, volatility suppressant, humectant and anti-microbial agent.

5. The formulation of claim 1 wherein the rubber crumb carrier comprises 1-35% carbon black.

6. The formulation of claim 1 wherein the diameter of the rubber crumb particle size falls within the range 0.01-2.00 mm.

7. The formulation of claim 1 wherein the rubber crumb carrier comprises 0.01-50% semiochemical(s) by weight of the formulation.

8. The formulation of claim 7 wherein the rubber crumb carrier comprises 0.5-50% semiochemical(s) by weight of the formulation.

9. The formulation of claim 1 wherein the amount of semiochemical(s) in the final formulation is 0.001-20% by weight.

10. The formulation of claim 1 wherein the water or aqueous medium comprises 0.1-5% thickener by weight for the formulation.

11. The formulation of claim 1 wherein the amount of rubber crumb and semiochemical(s) in the water or aqueous medium is 0.02-50% by weight of the formulation.

12. The formulation of claim 1 when used for the protection of crops, fruit, trees and plants.

13. The formulation of claim 1 when used for the control of arthropod pests.

14. The formulation of claim 1 when used for the control of flying insect pests such as moths, mosquitoes, flies, beetles and wasps.

15. The formulation of claim 1 when used for the protection of livestock and pets.

16. The formulation of claim 1 when used for the control of pests, such as cockroaches, ants, fleas, bedbugs and silverfish.

17. A method of preparing a formulation for controlling arthropod pests, said method including the steps of (i) admixing a carrier which includes rubber crumb with one or a plurality of hydrophobic or non-polar semiochemicals for a period of time sufficient for the rubber crumb to absorb the semiochemical, wherein the semiochemical(s) is substantially dispersed throughout the rubber crumb; and (ii) combining the rubber crumb mixture of step (i) with water or an aqueous medium as well as a thickener.

18. A method as claimed in claim 17 wherein in step (ii) the thickener is incorporated with the water or aqueous medium.

19. The method of claim 17 wherein the method includes the steps of adding one or more additives selected from the group consisting of a toxicant or insecticide, feeding stimulant or bait, pigment, volatility suppressant, humectant, anti-microbial agent and anti-oxidant.

20. The method of claim 19 wherein the toxicant or insecticide, feeding stimulant or bait, pigment, anti-microbial agent and humectant are admixed with the aqueous medium before the rubber crumb mixture is added in step (ii).

21. The method of claim 19 wherein the anti-oxidant and volatility suppressant is admixed with a semiochemical(s) before the semiochemical(s) is admixed with the carrier in step (i).

22. The formulation of claim 2 wherein the formulation comprises an additive which is an insecticide or toxicant.

23. The formulation of claim 2 wherein the amount of rubber crumb and semiochemical(s) in the water or aqueous medium is 0.02-50% by weight of the formulation.

24. The formulation of claim 3 wherein the amount of rubber crumb and semiochemical(s) in the water or aqueous medium is 0.02-50% by weight of the formulation.

25. The formulation of claim 4 wherein the amount of rubber crumb and semiochemical(s) in the water or aqueous medium is 0.02-50% by weight of the formulation.

26. The formulation of claim 22 wherein the amount of rubber crumb and semiochemical(s) in the water or aqueous medium is 0.02-50% by weight of the formulation.
